(19) United States
(12) Patent Application Publication
(10) Pub. No.: US 2004/0146707 A1
(43) Pub. Date: Jul. 29, 2004

(54) Heat radiating sheet

(75) Inventors: Masahiro Machida, Tokyo (JP); Akira Ohta, Tokyo (JP); Kouichiro Shimizu, Tokyo (JP); Yuuichi Deushi, Tokyo (JP); Masahito Nozue, Tokyo (JP)

Correspondence Address: VENABLE, BAETJER, HOWARD AND CIVILETTI, LLP, P.O. BOX 34385, WASHINGTON, DC, 20043-9998, US

(73) Assignees: Oki Electric Industry Co., Ltd., Tokyo (JP); Ceramission Co., Ltd., Tokyo (JP)

(21) Appl. No.: 10/735,739

(22) Filed: Dec. 16, 2003

(30) Foreign Application Priority Data
Dec. 16, 2002 (JP) JP2002-363326

(51) Int. Cl. B32B 5/16

(52) U.S. Cl. 428/328; 428/331

(57) ABSTRACT

The invention provides a heat radiating sheet which is not restricted by the shape and arrangement of a part to be cooled and which can be easily manufactured. A flexible heat radiating film having the effect of radiating infrared rays is formed on the front surface of a flexible heat absorbing layer having heat conductivity, and an adhesive layer consisting of a heat conductive adhesive agent is formed on the rear surface of the absorbing layer, so that the heat radiating sheet is formed to have flexibility.

### BACKGROUND OF THE INVENTION

1. Field of the Invention

The present invention relates to a heat radiating sheet used to cool various electronic parts such as optical parts or power semiconductors and electronic and electric products.

2. Description of the Related Art

A conventional heat radiating sheet radiates heat generated by an electronic part as follows. That is, a electric conductive layer side of a heat radiating plate formed such that an electric conductive layer constituted by a copper thin film formed by electroless plating or deposition on one surface of a heat radiating layer of a ceramic plate obtained by sintering a cordierite powder grain having a high emittance with respect to far infrared rays is caused to adhere to a circuit board on which the electronic part is mounted by a heat conductive adhesive agent having good heat conductivity (for example, Japanese Patent Laid-open Publication No. 10-116944 ([0018] to [0021] on the third page and FIG. 1).

However, in the above conventional technique, the ceramic plate obtained by sintering powder grain is used as a heat radiating layer. For this reason, in a case in which the heat radiating layer has high rigidity, a case in which the surface of a heat generating part to which a heat radiating plate is attached is not plane and is curved, or the like, the attachment is difficult.

Since the heat radiating layer is a ceramic plate, the heat radiating layer cannot be easily cut, a mold for shaping is required to obtain a necessary shape of a heat radiating sheet. The heat radiating sheet does not have high adaptability, and cannot be easily manufactured. For this reason, a manufacturer disadvantageous requires a large amount of labor.

### SUMMARY OF THE INVENTION

The present invention has been made to solve the above problem, and has as its object to provide a heat radiating sheet which is not restricted by the shape and arrangement of a part to be cooled and which can be easily manufactured.

In order to solve the above problem, the present invention provide a heat radiating sheet wherein a flexible heat radiating film having the effect of infrared radiation is formed on the front surface of a flexible heat absorbing layer having heat conductivity, and an adhesive layer consisting of a heat conductive adhesive agent is formed on the rear surface of the heat absorbing layer to achieve flexibility.

### BRIEF DESCRIPTION OF THE DRAWINGS

FIG. 1 is a perspective view showing an embodiment of the present invention.

FIG. 2 is a perspective view showing a setting state of a heat radiating sheet of the embodiment of the present invention.

FIG. 3 is a diagram for explaining a measurement point in evaluation test 1.

FIG. 4 is a side view showing a heat radiating plate in evaluation test 1.

FIG. 5 is a perspective view showing a heat generator in evaluation test 2.

FIG. 6 is an exploded perspective view showing a heat-radiating-sheet-attached product in evaluation test 2.

FIG. 7 is an exploded perspective view showing an aluminum-plate-attached product in evaluation test 2.

FIG. 8 is a perspective view showing a heat generator in evaluation test 3.

FIG. 9 is an exploded perspective view showing a heat-radiating-sheet-attached product in evaluation test 3.

FIG. 10 is an exploded perspective view showing an aluminum-plate-attached product in evaluation test 3.

FIG. 11 is a circuit diagram showing a temperature measurement circuit in evaluation test 3.

FIG. 12 is a perspective view showing heat generator in evaluation test 4.

FIG. 13 is an exploded perspective view showing a heat-radiating-sheet-attached product in evaluation test 4.

FIG. 14 is a diagram for explaining a measurement point of surface temperature in evaluation test 4.

### DETAILED DESCRIPTION OF THE PREFERRED EMBODIMENTS

An embodiment of a heat radiating sheet according to the present invention will be described below with reference to the accompanying drawings.

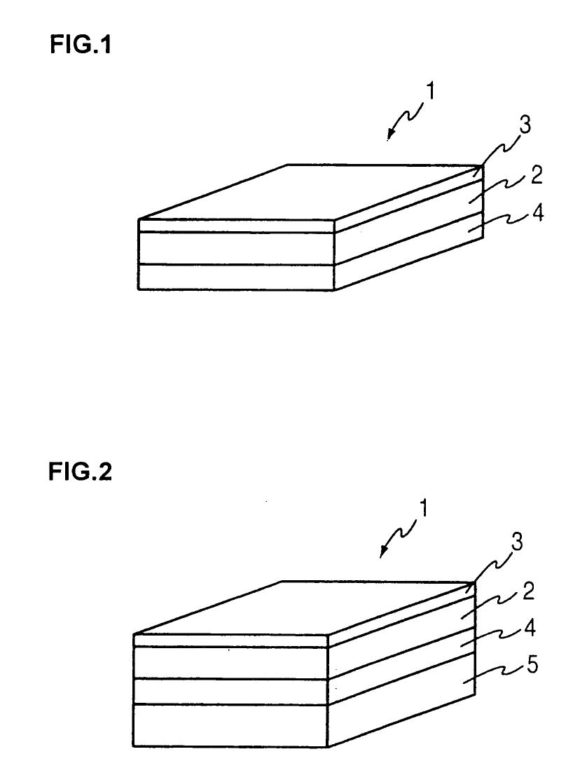

FIG. 1 is a perspective view showing an embodiment of the present invention, and FIG. 2 is a perspective view showing a setting state of the heat radiating sheet according to the embodiment.

A heat radiating sheet 1, as shown in FIG. 1, includes a heat absorbing layer 2, a heat radiating film 3, and an adhesive layer 4.

The heat absorbing layer 2 is a thin plate consisting of a metal material such as aluminum or an aluminum alloy, copper or a copper alloy, or a stainless steel and having heat conductivity. The heat absorbing layer 2 has flexibility such that the heat absorbing layer 2 can be bowed.

The heat radiating film 3 is a coating film formed on the front surface of the heat absorbing layer 2. The heat radiating film 3 has the effect of infrared radiation for converting transmitted heat into infrared rays or far infrared rays to radiate the infrared rays or the far infrared rays, and has flexibility such that the heat radiating film 3 can be bowed with relatively small force.

The heat radiating film 3 described above is formed is constituted by a coating film formed as follows. That is, a liquid obtained by mixing a binder in a powder containing silicon oxide and aluminum oxide, e.g., Ceramic a ((NIPPON CERAMIC. CO., LTD.) Japanese Trademark Registration No. 4577163) is directly sprayed on the front surface of the heat absorbing layer 2 with a sprayer or the like and then dried to obtain a coating film.

In order to form a similar coating film, a compound (called an emulsion compound) or the like obtained by containing a powder consisting of kaolin, silicon oxide, aluminum oxide, or the like in an emulsion containing a silicon resin is used. However, the forming method of the heat radiating film 3 is not limited to the forming method described in the above example. Any forming method which can a coating film having the effect of infrared radiation and flexibility may be used.

The adhesive layer 4 is formed by attaching or coating a tape consisting of a heat conductive adhesive agent or a heat conductive adhesive agent in which a heat conductive material is mixed to/on the rear surface of the heat absorbing layer 2.

In FIG. 2, the heat radiating sheet 1 is attached to the surface of a heat generator 5 with the adhesive layer 4.

The heat absorbing layer 2, the heat radiating film 3, and the adhesive layer 4 in the heat radiating sheet 1 consist of materials having heat resistance enough to withstand the temperature of heat generated by the heat generator 5, respectively, and consist of materials which are not melted at the temperature of the heat generated by the heat generator.

An operation of the above structure will be described below.

When the heat radiating sheet 1 according to this embodiment is to be manufactured, a relatively large metal thin plate for forming the heat absorbing layer 2 is subjected to pretreatment such as degreasing or surface treatment which is matched with the material of the metal thin plate.

A liquid for forming the heat radiating film 3, e.g., the ceramic a or the emulsion compound is directly coated on the front surface of the heat absorbing layer 2 with a brush, a sprayer, printing, dipping, or the like to cover the front surface such that an even film. The resultant film is dried at room temperature to form the heat radiating film 3.

The drying process at this time may be performed in a drying furnace. For example the film may be dried for about 1 hour in a drying furnace in which a temperature is kept at 125° C. In this manner, the manufacturing speed can be increased.

After the drying process is performed, the heat radiating sheet 1 is shaped by a cutting means such as scissors, punching, a straw cutter, or a laser according to the shape of the heat generator 5 to have a desired shape.

A tape consisting of a heat conductive adhesive agent is attached to the rear surface of the heat absorbing layer 2, or a heat conductive adhesive agent in which a heat conductive material is mixed is coated on the rear surface of the heat absorbing layer 2 to form the adhesive layer 4.

Shaping of the heat radiating sheet 1 may be performed as follows. That is, the adhesive layer 4 is formed by attaching a tape consisting of a heat conductive adhesive agent or coating a heat conductive adhesive agent after the drying process. Thereafter, the heat radiating sheet 1 is shaped by a cutting means to have a desired shape.

The heat radiating sheet 1, as shown in FIG. 2, is attached to the heat generator 5 by the adhesive layer 4 such that the heat radiating film 3 of the heat radiating sheet 1 faces outside.

At this time, the heat radiating film 3 according to this embodiment causes the binder such as a relatively soft silicon resin to adhere the contained powder grains and the front surface of the flexible heat absorbing layer 2 to each other. For this reason, since the heat radiating sheet 1 itself has flexibility, even though the surface shape of the heat generator is a convex shape or a concave shape, the heat radiating sheet 1 can be easily attached to the surface.

Therefore, the heat radiating sheet 1 can be easily and quickly attached to the heat generator 5 which must be cooled.

When the heat generator 5 starts to generate heat by turning on the heat generator 5, the heat is concentrically transmitted from the heat conductive adhesive agent having high heat conductivity to the adhesive layer 4 because heat radiation achieved by heat transmission to the ambient air layer is very poor, and, furthermore, the heat is transmitted to the heat absorbing layer 2.

The heat flowing into the heat absorbing layer 2 is uniformed in the heat absorbing layer 2, and the uniformed heat is transmitted to the heat radiating film 3.

The heat flowing into the heat radiating film 3 is converted into infrared rays and/or far infrared rays by the heat radiating film 3, so that heat radiation from the heat radiating film 3 to the outside is achieved.

In this manner, the heat generator 5 to which the heat radiating sheet 1 is attached is cooled to lower the temperature of the heat generator 5. The performance of an electronic part or the like having heat dependence can be kept, and the electronic part can be prevented from being erroneously operated.

Evaluation tests of four types (to be described below) were performed to evaluate the cooling effect of the heat radiating sheet 1.

Evaluation Test 1

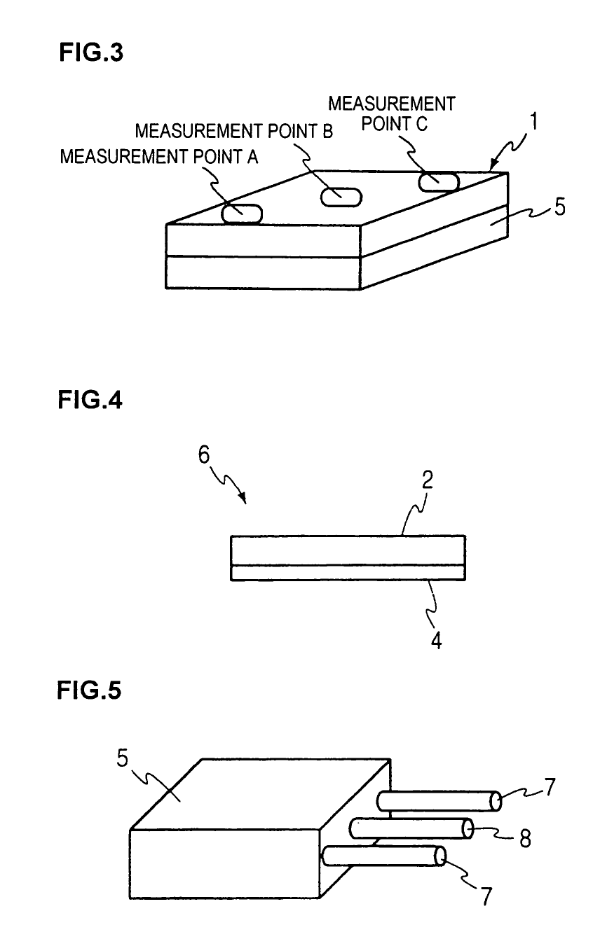

Samples used in Evaluation Test 1 are samples of three types: a heat generating independent product including a silicon rubber heater (width: 50 mm, length; 100 mm, thickness: 1 mm, rating: 45 W) shown in FIG. 3 as the heat generator 5; a heat-radiating-sheet-attached product obtained by attaching the heat radiating sheet 1 (width: 50 mm, length: 100 mm, heat radiating film thickness: 0.15 mm, heat absorbing layer thickness: 0.3 mm, adhesive layer thickness: 0.18 mm) including the aluminum alloy according to this embodiment as the heat absorbing layer 2 to the silicon rubber heater; and, for comparison, an aluminum-plate-attached product obtained by attaching the heat-radiating plate 6 constituted by a sheet obtained by removing the heat radiating film 3 from the heat radiating sheet 1, i.e., the aluminum plate (width: 50 mm, length: 100 mm, plate thickness: 0.3 mm) serving as the heat absorbing layer 2 shown in FIG. 4 and the adhesive layer 4 (adhesive layer thickness: 0.18 mm).

The heat radiating film 3 used in this evaluation test is a coating film formed by coating the ceramic a on the front surface of the heat absorbing layer 2 with a sprayer.

The adhesive layer 4 was formed by attaching a tape (Thermattach T405 tape available from TAIYO WIRE CLOTH CO., LTD.) consisting of a heat conductive adhesive agent to the rear surface of the heat absorbing layer 2.

Evaluation of the cooling effect in Evaluation Test 1 was performed as follows. That is, the samples of three types were arranged in a constant-temperature (25° C.) constant-humidity (45%) windless tank such that the samples were not in contact with the inner surface or a net rack in the constant-temperature constant-humidity tank, and the silicon rubber heater was turned on. Thermocouples were arranged on the front and rear surfaces of the samples at measurement point A, measurement point B, and measurement point C shown in FIG. 3, and the surface temperatures (surface temperatures on the front surfaces and the rear surfaces of the samples) at the measurement points were measured.

Table 1 shows the temperatures at the measurement points of the samples measured after electricity is conducted to the silicon rubber heater for 30 minutes to set the temperature of the heat generator 5 in an equilibrium state.

TABLE 1
Evaluation Result of Evaluation Test 1

| | | Heat | | | | |
|---|---|---|---|---|---|---|
| | | Generating | | | Heat- | |
| | | Independent | Aluminum-plate-attached | | radiating-sheet-attached | |
| | | Product | Product | | Product | |
| | | Measured | Measured | Temperature | Measured | Temperature |
| Item | | Temperature | Temperature | Change rate | Temperature | Change rate |
| Front | Measurement | 164.4° C. | 158.9° C. | −3% | 121.0° C. | −26% |
| Surface | Point A | | | | | |
| | Measurement | 147.9° C. | 133.3° C. | −10% | 121.2° C. | −18% |
| | Point B | | | | | |
| | Measurement | 147.6° C. | 136.5° C. | −8% | 112.3° C. | −24% |
| | Point C | | | | | |
| Rear | Measurement | 163.5° C. | 157.3° C. | −4% | 146.7° C. | −10% |
| Surface | Point A | | | | | |
| | Measurement | 146.2° C. | 137.4° C. | −6% | 128.7° C. | −12% |
| | Point B | | | | | |
| | Measurement | 156.0° C. | 148.9° C. | −5% | 141.4° C. | −9% |
| | Point C | | | | | |

As shown in Table 1, a temperature change rate corresponding to a heat generating independent product serving as a heat-radiating-sheet-attached product of this embodiment decreases by 18% to 26% on the front surface and decreases by 9 to 12%. In the aluminum-plate-attached product tested at the same time for comparison, a temperature change rate decreases by 3 to 10% on the front surface and decreases by 4 to 6% on the rear surface. Therefore, the decreasing rate of the heat-radiating-sheet-attached product is considerably larger than that of the aluminum-plate-attached product. It is understood that the heat radiating sheet 1 of this embodiment achieves excellent cooling effect even in an windless environment.

Evaluation Test 2

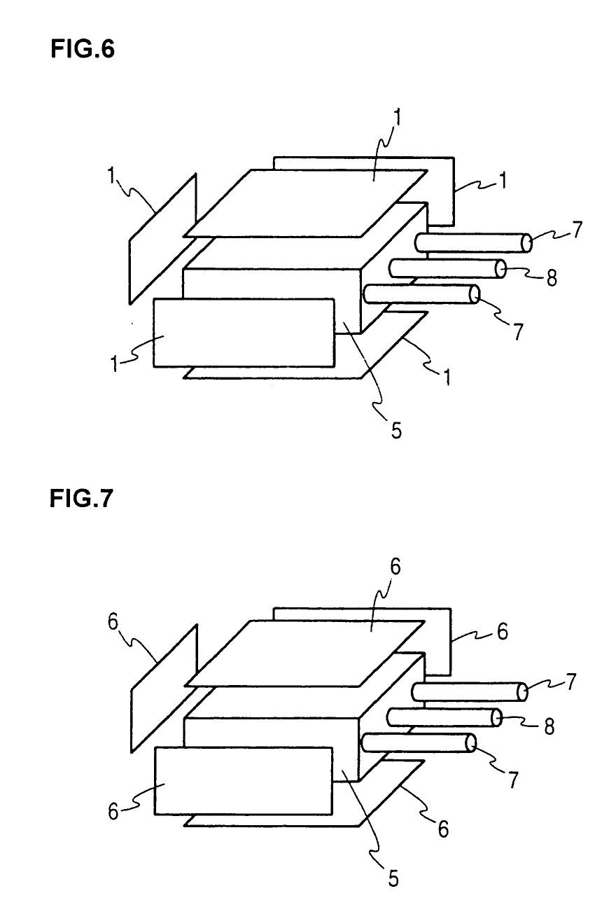

Samples used in Evaluation Test 2 are samples of three types: a heat generating independent product obtained by assembling two heaters 7 serving as the heat generator 5 shown in FIG. 5 and each having a rating of 100 W and a temperature measurement unit & for measuring a temperature at a central portion on a stainless plate (width: 40 mm, length; 40 mm, thickness: 20 mm); a heat-radiating-sheet attached product obtained by attaching the heat radiating sheets 1 (heat radiating film thickness: 0.1 mm, heat absorbing layer thicknesses: 1 mm, adhesive layer thickness: 0.18 mm) each including the aluminum alloy according to this embodiment as the heat absorbing layer 2 to five surfaces of the heat generator 5 shown in FIG. 6 (the two heat radiating sheets 1 each having a width of 40 mm and a length of 40 mm and the three heat radiating sheets 1 each having a width of 20 mm and a length of 40 mm are attached to the five surfaces of the heat generator 5); and, for comparison, an aluminum-plate-attached product obtained by attaching the same heat radiating plates 6 (aluminum plate thickness: 1 mm, adhesive layer thickness: 0.18 mm) as used in Evaluation Test 1 to the five surface of the heat generator 5 shown in FIG. 7 (the two heat radiating plates 6 each having a width of 40 mm and a length of 40 mm and the three heat radiating plates 6 each having a width of 20 mm and a length of 40 mm are attached to the five surfaces).

The heat radiating film 3 used in this evaluation test is a coating film formed by coating the emulsion compound on the front surface of the heat absorbing layer 2 with a sprayer. A product “POLON-MF-56 available from Shin-Etsu chemical Co., Ltd. is used as an emulsion containing a silicon resin. The emulsion is obtained by adding and mixing emulsion, kaolin, silicon oxide, aluminum oxide, titanium oxide, and zirconium oxide (51:12.5:8:13:5:8 as a weight ratio).

The adhesive layer 4 is the same as the adhesive layer 4 in Evaluation Test 1.

Evaluation of the cooling effect of Evaluation Test 2 was performed as follows. That is, the samples of three types were arranged in a constant-temperature (25° C.) constant-humidity (45%) windless tank, and the heaters 7 were turned on, and the temperature of the central portion of the heat generator was measured by the temperature measurement unit 8 shown in FIG. 4.

Table 2 shows measured temperatures of the respective samples measured after electricity is conducted to the heaters 7 for 2 hours at supply powers of 2 W, 5 W, and 8 W to set the temperature of the heat generator 5 an equilibrium state.

TABLE 2
Evaluation Result of Evaluation Test 2

| | | Heat | | |
|---|---|---|---|---|
| | | Generating | | |
| | Applied | Independent | Aluminum- | Heat-radiating- |
| Item | Power | Product | attached Product | sheet-attached |
| Measured | 2 W | 60.2° C. | 58.4° C. | 48.8° C. |
| Temperature | 5 W | 98.8° C. | 98.5° C. | 76.0° C. |
| | 8 W | 133.6° C. | 134.8° C. | 102.6° C. |
| Temperature | 2 W | Reference | −3% | −19% |
| Change Rate | 5 W | Reference | −0.3% | −23% |
| | 8 W | Reference | 0.9% | −23% |

As shown in Table 2, the temperature change rates of the heat generating independent product serving as a heat-radiating-sheet-attached product of this embodiment decreases by 19% at a supply power of 2 W, 23% at 5 W, and 23% at 8 W. In the aluminum-plate-attached product tested at the same time for comparison, a temperature change rate decreases by 3% at 2 W and 0.3% at 5 W and increases by 0.9% at 8 W. Therefore, the decreasing rate of the heat-radiating-sheet-attached product is considerably larger than that of the aluminum-plate-attached product. It is understood that the heat radiating sheet 1 of this embodiment achieves excellent cooling effect even in an windless environment.

Evaluation Test 3

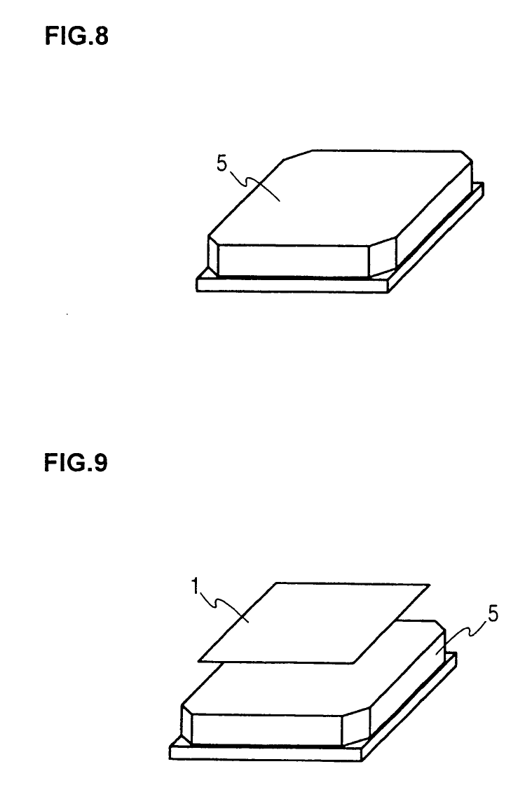

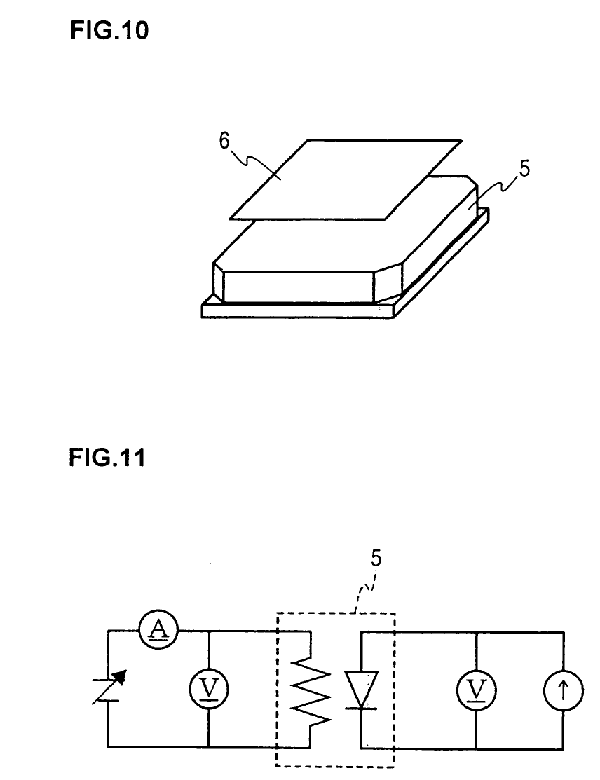

Samples used in Evaluation Test 3 are samples of five types: a heat generating independent product using, as the heat generator 5, a measurement semiconductor element (width: 12.4 mm, length: 12.4 mm, thickness: 1.3 mm) in which a register and a diode shown in FIG. 8 are built; heat-radiating-sheet-attached products obtained by attaching the heat radiating sheets 1 (width: 10.5 mm, length: 10.5 mm, heat radiating film thickness: 0.1 mm, heat absorbing layer thicknesses: 1 mm and 0.3 mm, adhesive layer thickness: 1 mm) including the aluminum alloy according to this embodiment as the heat absorbing layer 2 to the surface of the heat generator 5 shown in FIG. 9; and, for comparison, aluminum-plate-attached products obtained by attaching the same heat radiating plates 6 (width: 10.5 mm, length: 10.5 mm, aluminum plate thicknesses: 1 mm and 0.3 mm, adhesive layer thickness: 1 mm) as used in Evaluation Test 1 to the surfaces of the heat generators 5 shown in FIG. 10.

The heat radiating film 3 used in this evaluation test is the heat absorbing layer 2 consisting of the same emulsion compound as that in Evaluation Test 2.

The adhesive layer 4 was formed by attaching an acrylic tape 9894FR available from SUMITOMO 3M LTD.) consisting of a heat conductive adhesive agent to the rear surface of the heat absorbing layer 2.

Evaluation of the cooling effect of Evaluation Test 3 was performed as follows. That is, the samples of five types were arranged in a constant-temperature (25° C.) constant-humidity (45%) windless tank, and temperature measurement circuits shown in FIG. 11 were formed on the diode and the resistor of the measurement semiconductor element.

The temperature measurement was performed as follows. That is, while a constant current is flowed from a constant current source to the diode of the measurement semiconductor element, a voltage between the anode and the cathode of the diode was measured, and calculation was performed by the following equations:

Heat generator temperature=(reference voltage−measured voltage)/temperature coefficient+reference temperature (1)

A target power is supplied as follows. That is, the resistor of the measurement semiconductor element is used as heater, a voltage and a current at both the ends of the resistor are measured to always supply a constant target power, and a voltage expressed by the following equation is applied to the resistor by a variable power supply.

Applied voltage=(target power×present voltage/present current)^{0.5} (2)

The temperature measurement according to Equation (1) was performed as follows. That is, the voltmeter, the ammeter, and the variable power supply were connected to a computer having an automatic measurement program with communication to perform measurement under predetermined conditions. Temperatures were periodically measured by the system, and the measurement results are stored in the computer.

Table 3 shows temperatures of the samples measured after the target power is set at 1 W and the voltage expressed by Equation (2) is applied to the resistor for 20 minutes to set the temperature of the heat generator 5 in an equilibrium state.

TABLE 3
Evaluation result
of Evaluation Test 3

| | | Aluminum-plate- | | Heat-radiating- | |
|---|---|---|---|---|---|
| | Heat | attached Product | | sheet-attached Product | |
| | Generating | Plate | Plate | Heat | Heat |
| | Independent | Thickness | Thickness | Absorbing | Absorbing |
| Item | Product | 1.0 mm | 0.3 mm | Layer 1.0 mm | Layer 0.3 mm |
| Measured | 149.8° C. | 139.0° C. | 136.6° C. | 136.2° C. | 129.7° C. |
| Temperature | | | | | |
| Temperature | Reference | −7% | −9% | −9% | −13% |
| Change Rate | | | | | |

As shown in Table 3, the temperature change rates of the heat generating independent product serving as a heat-radiating-sheet-attached product of this embodiment decreases by 9% when the heat absorbing layer 2 has a thickness of 1 mm and 13% when the heat absorbing layer 2 has a thickness of 0.3 mm. In the aluminum-plate-attached product tested at the same time for comparison, a temperature change rate decreases by 7% when the plate thickness is 1 mm and 9% when the plate thickness is 0.3 mm. Therefore, it is understood that the heat radiating sheet 1 of this embodiment achieves excellent cooling effect even in an windless environment.

It is also understood that the cooling effect is more improved by thinning the heat absorbing layer 2.

Evaluation Test 4

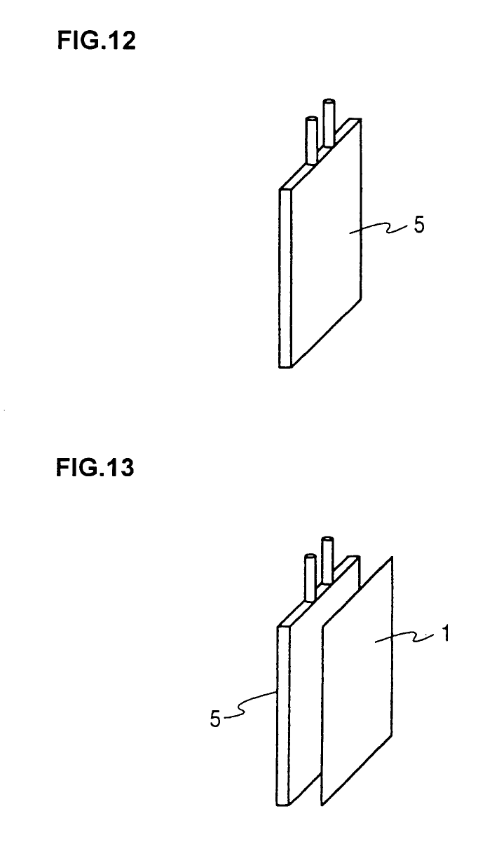

Samples used in Evaluation Test 4 are samples of two types: a heat generating independent product using, as the heat generator 5, a silicon rubber heater (width: 50 mm, length: 100 mm, thickness: 1 mm, rating: 45 W) shown in FIG. 12; and a heat-radiating-sheet-attached product obtained by attaching the heat radiating sheet 1 (width: 50 mm, length: 100 mm, heat radiating film thickness: 0.1 mm, heat absorbing layer thicknesses: 0.3 mm, adhesive layer thickness: 0.18 mm) using the aluminum alloy according to this embodiment as the heat absorbing layer 2 to the surface of the heat generator 5 shown in FIG. 13.

The heat radiating film 3 used in this test is the heat absorbing layer 2 consisting of the same emulsion compound as that in Evaluation Test 2, and the adhesive layer 4 is the same as the adhesive layer 4 used in Evaluation Test 1.

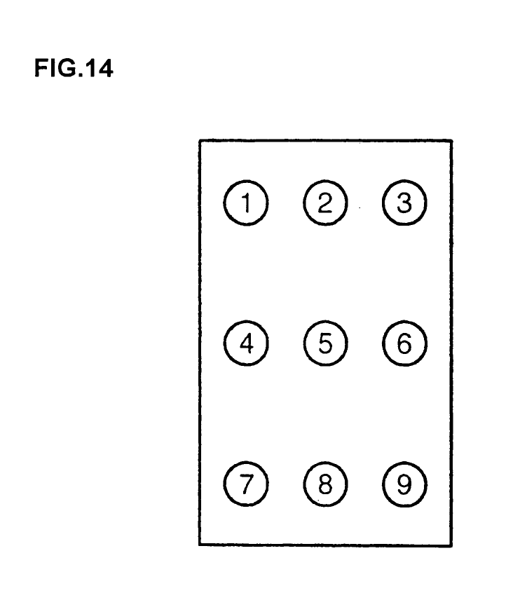

Evaluation of the cooling effect of Evaluation Test 4 was performed as follows. That is, the samples of two types were arranged in a constant-temperature (25° C.) constant-humidity (45%) windless tank, the silicon rubber heater serving as the heat generator 5 is turned on, and temperatures at nine measurement points were measured by a thermography shown in FIG. 14.

Table 4 shows surface temperatures (surface temperatures of the heat generator 5 in the heat generating independent product and surface temperatures of the heat radiating film 3 in the heat-radiating-sheet-attached product) at measurement points of the respective samples after powers of 10 W and 18 W are supplied to the heat generator 5 for two hours in the above state to set the temperature of the heat generator 5 in an equilibrium state.

TABLE 4
Evaluation Result of Evaluation Test 4

Unit: ° C.

| | Heat Generating | | Heat-radiating-sheet- | |
|---|---|---|---|---|
| | Independent Product | | attached Product | |
| Measurement Point | 10 W | 18 W | 10 W | 18 W |
| 1 | 104.9 | 154.1 | 77.3 | 100.5 |
| 2 | 90.1 | 132.9 | 80.1 | 100.5 |
| 3 | 107.1 | 155.0 | 79.0 | 104.7 |
| 4 | 109.7 | 161.1 | 79.8 | 108.8 |
| 5 | 97.1 | 136.5 | 81.4 | 110.8 |
| 6 | 111.3 | 158.8 | 80.6 | 109.7 |
| 7 | 95.7 | 137.0 | 73.8 | 106.6 |
| 8 | 86.2 | 117.1 | 73.7 | 109.2 |
| 9 | 98.5 | 139.7 | 70.0 | 106.9 |
| Average | 100.1 | 143.6 | 77.3 | 106.4 |
| Standard Deviation | 8.8 | 14.6 | 3.9 | 3.8 |

| | | |
|---|---|---|
| Average Change Rate of Heat Generating | −23% | −26% |
| Independent Product | | |
| Standard Deviation Change Rate of Heat | −55% | −74% |
| Generating Independent Product | | |

As shown in Table 4, the average and variation of the surface temperatures of the heat-radiating-sheet-attached product according to this embodiment are smaller than those of the heat generating independent product. An average temperature change rate decreases by 19% at a supply power of 10 W and decreases by 26% at a supply power of 18 W. A standard deviation change rate decreases by 55% at a supply power of 10 W and decreases by 74% at a supply power of 18 W.

In this manner, it is understood that the heat radiating sheet 1 of this embodiment achieves excellent cooling effect and characteristics which are good at uniforming the surface temperature even in a windless environment.

The characteristics which are good at uniforming the surface temperature are especially effective when heat generating parts such as resistors are dispersally arranged in various places of the heat generator 5 such as an integrated circuit.

As described above, according to this embodiment, a heat radiating film having the effect of radiating infrared rays is formed on the front surface of the heat absorbing layer, so that a heat radiating sheet which are good at cooling effect can be obtained.

Since a coating film is used as a heat radiating film, and a heat absorbing layer is constituted by a thin metal material consisting of aluminum or stainless steel, the heat radiating film and the heat absorbing layer can be shaped by cutting. For this reason, a heat radiating sheet having a proper shape depending on the shape of a heat generator can be easily manufactured, and a load on a manufacturer can be reduced.

In addition, a heat radiating sheet having flexibility is constituted by a flexible heat radiating film and a flexible heat absorbing layer. For this reason, even though the surface shape of the heat generator is a convex shape or a concave shape, the heat radiating sheet can be easily attached to the surface of the heat generator by using the flexibility of the heat radiating sheet.

The flexibility and the formability make it possible to obtain a heat radiating sheet which can achieve excellent cooling capability regardless of the shape of a part to be cooled.

In addition, since an adhesive layer consisting of a heat conductive adhesive agent is formed on the rear surface of the absorbing layer, the self-adhesion of the heat radiating sheet makes it possible to attach the heat radiating sheet to an electronic part or the like which is obliquely, vertically, or inversely arranged. The heat radiating sheet can cool a heat generator which is arranged in any manner.

Furthermore, since excellent cooling effect is obtained by a thin heat radiating sheet having the same size as that of a heat generator, an integrated circuit or the like arranged at a small place where cooling by a conventional radiator with fin is very difficult can be easily performed without wind. A cooling fan, a radiator with fin, or the like can be omitted to achieve a reduction in size of an electronic device and simplification of the electronic device and to reduce energy consumption.

Ceramic α, an emulsion compound, or the like is directly coated on a heat absorbing material to form a heat radiating film. The heat radiating film is attached by an adhesive layer. Therefore, the heat radiating film can be easily attached to a part on which the heat radiating film cannot easily directly formed, e.g., a part such as an integrated circuit which requires pretreatment such as degreasing or a part such as a casing of a motor which has been painted. These heat generators can be effectively cooled.

The above embodiment is described and illustrated such that the heat radiating sheet is attached to the almost entire surface of the heat generator. However, the heat radiating sheet may be attached to a part which must be cooled. When cooling must be locally performed, the heat radiating sheet may be locally attached.

As described above, according to the present invention, a heat radiating film having the effect of radiating infrared rays and flexibility is formed on the front surface of a flexible absorbing layer, and an adhesive layer consisting of a heat conductive adhesive agent is formed on the rear surface of the heat absorbing layer. Therefore, a heat radiating sheet which is not restricted by the shape and arrangement of a part to be cooled, which can be easily manufactured, and which has excellent cooling effect can be obtained.

What is claim d is:

1. A heat radiating sheet comprising:
a flexible heat absorbing layer having heat conductivity;
a flexible heat radiating film formed on the front surface of the heat absorbing layer and having the effect of radiating infrared rays; and
an adhesive layer consisting of a heat conductive adhesive agent and formed on the rear surface of the heat absorbing layer, wherein
the heat radiating sheet has flexibility.

2. A heat radiating sheet according to claim 1, wherein
the heat radiating film having the effect of radiating infrared rays is a coating film formed by coating a liquid containing silicon oxide and aluminum oxide.

3. A heat radiating sheet according to claim 1, wherein
the heat radiating film having the effect of radiating infrared rays is a coating film formed by coating an emulsion compound containing kaolin.

4. A heat radiating sheet according to claim 1, wherein the heat absorbing layer is a metal thin film.

5. A heat radiating sheet according to claim 1, wherein
the heat radiating film having the effect of radiating infrared rays is a coating film formed by coating a liquid containing silicon oxide and aluminum oxide, and
the heat absorbing layer is a metal thin film.

6. A heat radiating sheet according to claim 1, wherein
the heat radiating film having the effect of radiating infrared rays is a coating film formed by coating an emulsion compound containing kaolin, and
the heat absorbing layer is a metal thin film.
